(19) United States
(12) Patent Application Publication
(10) Pub. No.: US 2007/0015110 A1
(43) Pub. Date: Jan. 18, 2007

(54) PROSTHETIC DENTAL DEVICE

(75) Inventors: Kai Zhang, Warsaw, IN (US); Ryan M. Donahoe, San Diego, CA (US); Thomas H. Day, Carlsbad, CA (US); Hallie P. Brinkerhuff, Winona Lake, IN (US); Jeffrey A. Bassett, Vista, CA (US)

Correspondence Address: ZIMMER TECHNOLOGY - BAKER & DANIELS, 111 EAST WAYNE STREET, SUITE 800, FORT WAYNE, IN, 46802, US

(73) Assignee: ZIMMER DENTAL, INC., Carlsbad, CA (US)

(21) Appl. No.: 11/420,024

(22) Filed: May 24, 2006

Related U.S. Application Data
(60) Provisional application No. 60/684,743, filed on May 26, 2005.

(51) Int. Cl. A61C 8/00

(52) U.S. Cl. 433/173; 433/201.1

(57) ABSTRACT

A prosthetic dental device comprised of a composite material including a polymer material and a ceramic material mixed within the polymer material. In one embodiment, the ceramic fillers are substantially, homogeneously dispersed within the polymer material. In one embodiment, the ceramic material is bonded to the polymer material through a coupling agent. In addition, the prosthetic dental device can be comprised of a different composite material. This composite material includes a ceramic matrix having pores and an organic material infiltrated into the pores. To construct the ceramic matrix, ceramic particles, a binder material, and a porogen material are mixed to create a composite material which is then molded and heated to create a substantially rigid ceramic structure. At least some of the binder material and the porogen material are evaporated during the heating step to create pores in the matrix which are filled with the organic material.

### CROSS REFERENCE TO RELATED APPLICATION

This nonprovisional patent application claims priority under 35 U.S.C. § 119(e) to U.S. Provisional Patent Application Ser. No. 60/684,743 filed May 26, 2005, the disclosure of which is explicitly incorporated by reference herein.

### BACKGROUND

1. Field of the Invention

The present invention relates to prosthetic dental devices. The present invention also relates to methods and materials used to construct prosthetic dental devices.

2. Description of the Related Art

Often, it is desirable to replace lost, missing, injured or diseased teeth using prosthetic dental devices. Prosthetic dental devices include, e.g., implants which are inserted into the mandible or maxilla of a patient, gingival cuffs, healing screws, healing collars and healing caps which are attached to the implants during the healing process, abutments which are attached to the implant to serve as a mount for a prosthetic tooth, and provisional and temporary devices which are used during the healing process.

### SUMMARY

In one form of the invention, a prosthetic dental device includes a body comprised of a compound, or composite, material. In one embodiment, the composite material includes a polymer material and a ceramic filler material. The body includes a matrix comprised of the polymer material having ceramic filler material mixed therein. To construct this embodiment, a method may be used including mixing the ceramic filler material in the polymer material to create a composite material, heating the composite material, and injecting the composite material into a mold. In one embodiment, the ceramic filler material is substantially, homogeneously dispersed in the polymer material. In another embodiment, a coupling agent is applied to the composite material to facilitate chemical bonding between the polymer material and the ceramic filler material. In another embodiment, the coupling agent is applied to the ceramic filler material before it is mixed with the polymer material.

In another form of the invention, a prosthetic dental device includes a body which is comprised of another compound, or composite, material. In one such embodiment, the composite material includes a ceramic matrix having pores and an organic material contained within the pores. To construct the ceramic matrix, a method may be used including mixing ceramic particles and a binder material to create a fluid, inserting a quantity of the fluid into a mold, and heating the fluid to create a substantially rigid ceramic structure of the dental device. In one embodiment, the fluid is viscous. To create pores in the ceramic matrix, a quantity of the binder material is volatilized, or evaporated, during the heating step leaving behind pores in the ceramic matrix. In another embodiment, a porogen material, such as wax particles, are mixed into the composite material and evaporated during the heating step to create additional pores. Thereafter, an organic material, such as a thermoset monomer resin, can be introduced into the pores of the ceramic matrix. The ceramic matrix and/or thermoset monomers are heated to allow the monomers to polymerize and bond to the ceramic matrix. In one embodiment, an initiator is added to the composite material to facilitate the polymerization of the monomers. In another embodiment, a coupling agent is used to facilitate chemical bonding between the organic material and the ceramic material.

Dental prostheses comprised of these materials are strengthened by the ceramic material component and toughened by the organic or polymer material component.

In one form of the invention, a prosthetic dental device comprises a body formed of a composite material, the composite material including a polymer material and a ceramic material mixed within the polymer material, the composite material having a tensile modulus greater than or equal to 630 ksi.

In one form of the invention, a prosthetic dental device comprises a body comprised of a composite material, the composite material including a polymer material and a ceramic material mixed within the polymer material, the ceramic material including a plurality of fibers, each fiber defining a longitudinal axis and variable cross-sections transverse to the axis defining relatively wide first portions connected by relatively narrow second portions and pockets defined intermediate adjacent first and second portions, the polymer material received within the pockets.

In one form of the invention, a method of producing a composite orthopaedic prosthesis comprises determining a desired ratio of composite constituents, providing a quantity of ceramic particles, the ceramic particles comprising one of the composite constituents, providing a quantity of porogen particles, mixing the ceramic particles with the porogen particles to form a mixture of ceramic and porogen particles, heating the mixture at a temperature sufficient to evaporate at least some of the porogen particles, whereby the heating step creates a quantity of pores in the mixture of sufficient size and number to achieve the desired ratio of composite constituents when at least one additional composite constituent is introduced into the pores, and introducing an organic material into the pores, the organic material comprising an additional composite constituent.

In one form of the invention, a prosthetic dental device comprises an implant coupling structure configured to connect the dental device to an implant, and a body comprised of a composite material including a polymer material and ceramic nanoparticles dispersed within the polymer material.

In one form of the invention, a prosthetic dental device includes an implant coupling structure configured to connect the dental device to an implant, characterized by a body comprised of a composite material including a polymer material, and a ceramic material dispersed within the polymer material.

In one form of the invention, a prosthetic dental device comprises a reinforcing element, and a composite material molded about the reinforcing element to form the dental device, the composite material comprised of a polymer material and a ceramic material dispersed within the polymer material.

### BRIEF DESCRIPTION OF THE DRAWINGS

The above-mentioned and other features of this invention, and the manner of attaining them, will become more apparent and the invention itself will be better understood by reference to the following description of embodiments of the invention taken in conjunction with the accompanying drawings, wherein:

FIG. 1 is an exploded, fragmentary, perspective view of a dental implant, healing screw and a portion of a patient's mandible;

FIG. 2 is a fragmentary, cross-sectional view of a portion of the dental implant of FIG. 1 illustrating a first composition in which ceramic fibers are mixed within the body of the implant;

FIG. 3 is a fragmentary, cross-sectional view of a portion of the dental implant of FIG. 1 illustrating a second composition in which semi-spherical particles are dispersed within the body of the implant;

FIG. 4 is a fragmentary, cross-sectional view of a portion of the dental implant of FIG. 1 illustrating a third composition in which pores are in the body of the implant;

FIG. 5 is a fragmentary, cross-sectional view of the dental implant of FIG. 4 with an organic material in the pores;

FIG. 6 is a block diagram showing steps of a first exemplary process for manufacturing a dental prosthetic device in accordance with the present invention;

FIG. 7 is a block diagram showing steps of a second exemplary process for manufacturing a dental prosthetic device in accordance with the present invention;

FIG. 8 is a perspective view of an abutment in accordance with the present invention;

FIG. 9 is a cross-sectional view of the abutment of FIG. 8 taken along section line 9-9;

FIG. 10 is a fragmentary, cross-sectional view of a portion of a dental implant including ceramic fibers having a thickness that varies along the length of the fiber; and

FIG. 11 is a detail view of a portion of the dental implant of FIG. 10.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION

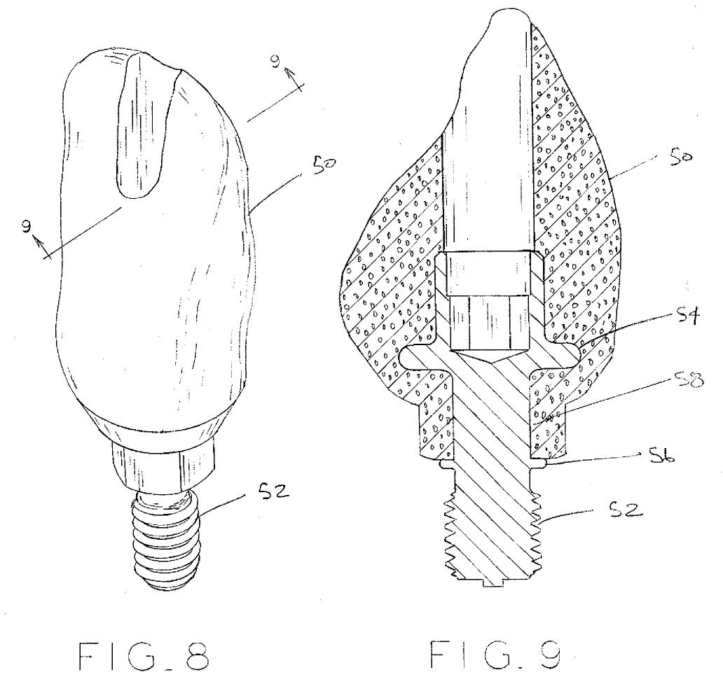

As discussed above, prosthetic dental devices are used to replace lost, missing, injured or diseased teeth. An exemplary device, dental implant 20, is illustrated in FIG. 1. Implant 20 includes threaded portion 22 for engaging a hole 24 in mandible 26, which is created during a surgical procedure or following tooth extraction as is well known in the art. Similarly, hole 24 could be placed in a patient's maxilla. Healing screw 28 is also illustrated in FIG. 1. Healing screw 28 includes threaded shaft 30 extending from head 32. Threaded shaft 30 engages threaded aperture 33 of implant 20. Healing screw 28 prevents debris from entering, and gingival tissue from growing into, aperture 33 while the mandible heals during the osseointegration of implant 20 with mandible 26. A dental device including a healing cap or a gingival cuff, or a prosthetic component such as an abutment may also be coupled to implant 20 in a conventional manner. A healing cap is similar to a healing screw but is used with a one-piece implant or when the abutment is placed on the implant at the time of surgery. An abutment serves as an adapter between the implant and a prosthetic tooth. A prosthetic tooth typically includes an inner cavity designed to accept an abutment and an outer portion that replicates the appearance and hardness of a natural tooth. In some embodiments, the prosthetic tooth is cemented to the abutment. In other embodiments, a screw fastens the prosthetic tooth to the abutment. Other prosthetic dental devices, such as provisional devices, may be temporarily or provisionally used during osseointegration between the implant and the bone. Provisional devices are often used while a restoration is being fabricated. For example, a temporary abutment may be affixed to an implant for supporting a temporary coping, including a tooth-shaped coping, i.e., a crown, thereon. After the final restoration has been fabricated, the temporary abutment and crown are removed and the final restoration is attached to the implant. The final restoration may include a final custom abutment and a custom crown, or coping, fit over the abutment. Although the materials described herein have been described in connection with an exemplary implant (FIG. 1) and an exemplary abutment (FIGS. 8 and 9), the materials disclosed herein can also be used to produce a wide range of other dental prostheses.

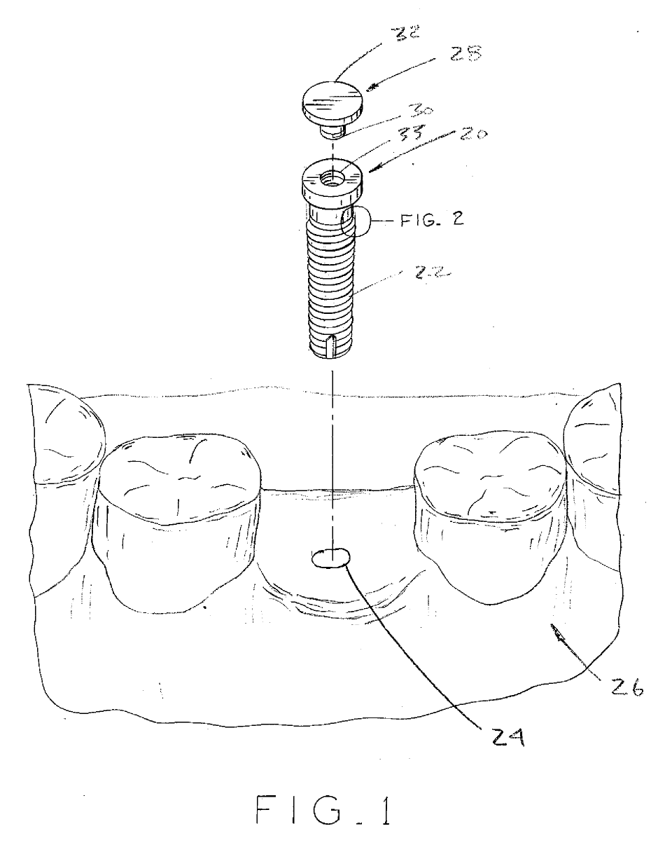

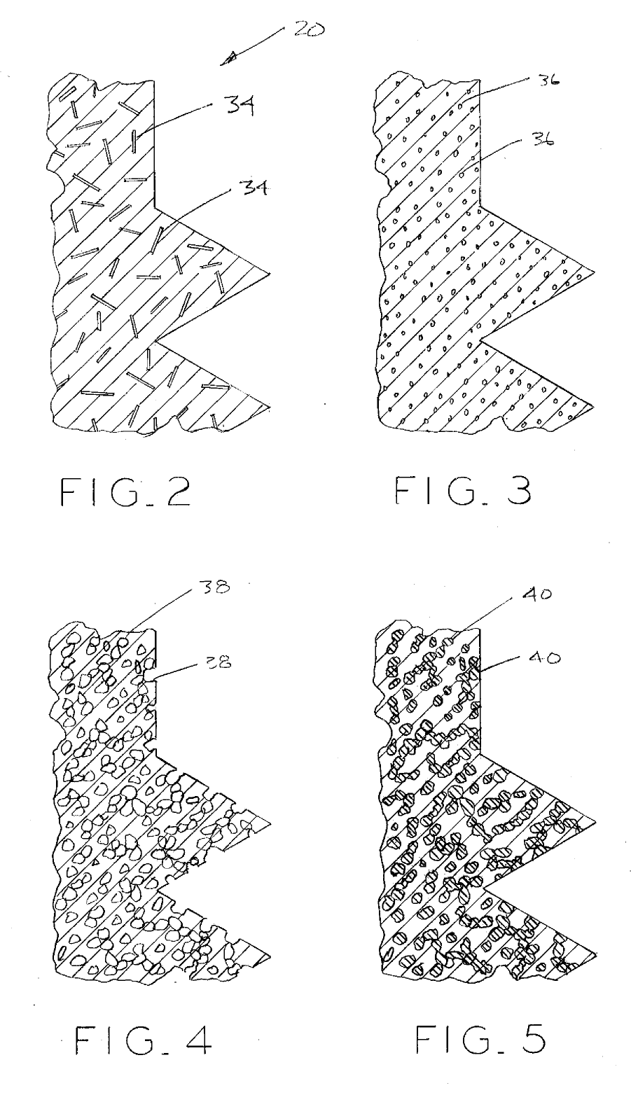

In one embodiment of the invention, dental devices, including implant 20, healing screw 28, or an abutment, for example, are constructed from a composite material. The composite material includes a polymer material and a ceramic filler material. In one embodiment, a body of the dental device includes a matrix comprised of polymer material with a ceramic filler material mixed within the polymer matrix, as illustrated in FIGS. 2 and 3. The polymer material can be a thermoplastic polymer including, without limitation, aromatic polyether ketones such as polyether ether ketone (PEEK), polymethylmethacrylate (PMMA), polyaryl ether ketone (PAEK), polyether ketone (PEK), polyether ketone ether ketone ketone (PEKEKK), polyether ketone ketone (PEKK), and/or polyetherimide (PEI), polysulfone (PSu), and polyphenylsulfone (PPSu), or a combination of thermoplastic polymers. One suitable polyetherimide is Ultem® polyetherimide available from General Electric Plastics, headquartered in Pittsfield, Mass. (Ultem® is a registered trademark of the General Electric Company). One suitable polyphenylsulfone is Radel® polyphenylsulfone available from Solvay Advanced Polymers, headquartered in Alpharetta, Ga. (Radel® is a registered trademark of Solvay Advanced Polymers, LLC). The ceramic filler material is mixed into the polymer material to strengthen and reinforce the polymer material.

The ceramic filler material can be particles or fibers of a ceramic material including, without limitation, yttria-stabilized zirconia, magnesium-stabilized zirconia, alumina, titanium dioxide, calcium phosphates such as hydroxyapatite or a biphasic calcium phosphate comprised of hydroxyapatite and tricalcium phosphate, or a combination of ceramic materials. Calcium phosphates may be used to improve the osseointegration of the dental device within the bone, if necessary. The proportion of ceramic filler material within the composite material may be as low as about 7%, 10%, 14%, 20%, or 30% by weight of the composite material, or as high as about 40%, 50%, 60%, or 70% by weight of the composite material. In one embodiment, the ceramic filler material can include any suitable glass material. In other embodiments, the filler material can include any suitable organic, inorganic and/or non-metallic material.

The ceramic filler material can include, without limitation, spherical shapes, elongate fibers, or other shapes. The ceramic particles can have size ranges from about 1 nm to about 100 nm, i.e., nanoparticles, and/or from about 100 nm to about 100 μm, i.e., microparticles. The elongate fibers, such as fibers 34 (FIG. 2), can have a substantially constant thickness or diameter. In one embodiment, the diameter of the fibers can range in size from nanometer to millimeter and the ratio of the fiber length to the fiber diameter can be between about 10 to about 1000. In other embodiments, this ratio can be as low as about 10, 20, or 25 and as high as about 100, 150 or 1000. In the present embodiment, the length of the fibers is about 1 mm. In other embodiments, the length of the fibers can be as short as about 0.25 mm and as long as about 1 mm.

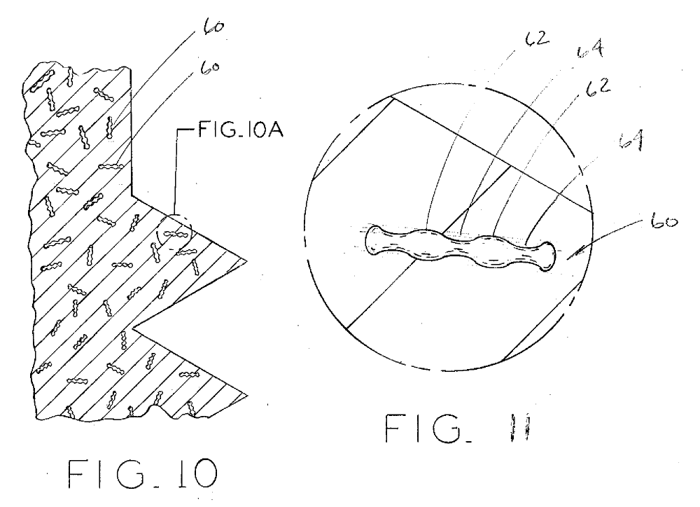

In one embodiment, illustrated in FIG. 10, the elongate fibers can have a thickness or diameter that varies along the length of the fiber. These variable-thickness or variable-diameter fibers, such as fibers 60 of FIGS. 10 and 11, can have a substantially repeating pattern of portions or segments having alternating larger and smaller cross-sections, such as sections 62 and 64, respectively, along the length of the fiber. As a result, when these fibers are mixed into the polymer material, the polymer material can fill into the “pockets” defined by the portions having smaller cross-sections between the portions having larger cross-sections, such that the fibers mechanically interlock with the polymer matrix thereby improving the resistance to stress and wear of the composite material. Stated another way, these fibers can have an undulating profile defining relatively wide portions and relatively narrow portions where the plastic material fills between the wide portions of the fiber profile.

In other embodiments, combinations of particles, such as particles 36 (FIG. 3), and fibers 34 (FIG. 2) can be utilized. In one embodiment, the ceramic filler material is distributed or dispersed substantially evenly throughout the polymer material thereby improving the reliability and predictability of the composite material's properties and performance. In an alternative embodiment, the ceramic filler material can include fibers having nanoparticles that are fused or bonded onto the fiber surface through a thermal process. These fused ceramic materials can, for example, improve the fracture toughness of the composite material. In one embodiment, zirconia particles can be heated and fused onto zirconia fibers. In a further embodiment, titanium dioxide particles, or other colorants, for example, can be fused onto zirconia fibers, for example. In these embodiments, the composite material can have enhanced material properties and a desired color provided by the fused ceramic materials.

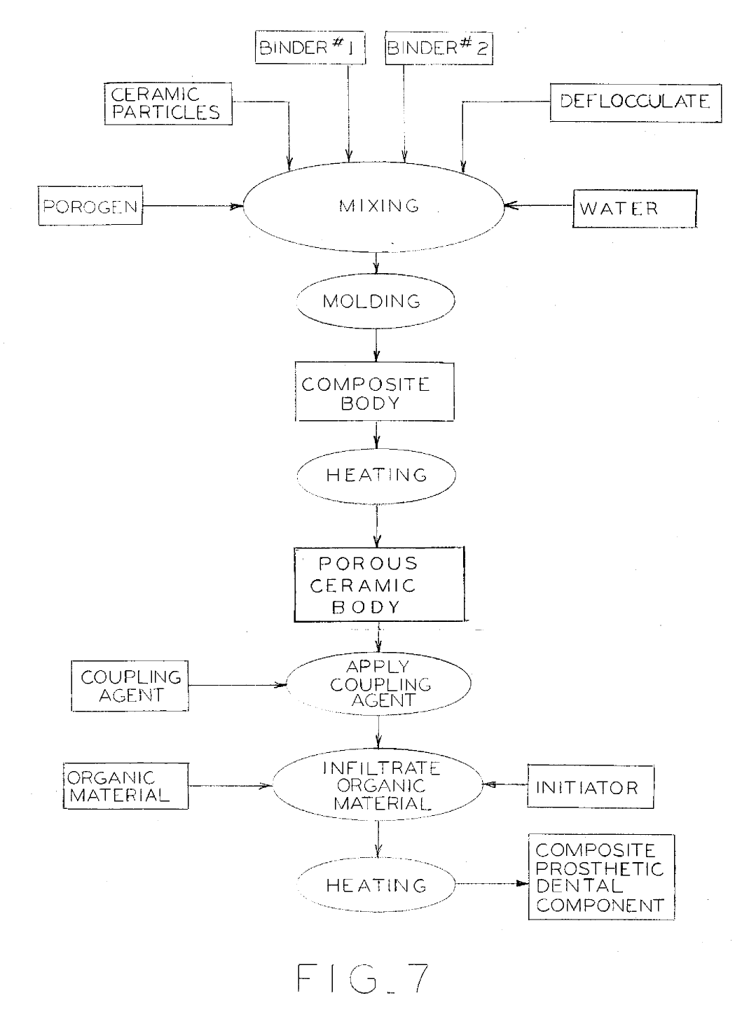

The dental devices discussed above can be made using an injection molding process. Prior to the injection molding process, the composite material can be produced through a compounding process. In this compounding process, referring to FIG. 6, a mixture of the polymer material and the ceramic filler material can be heated into a viscous state and mechanically mixed into a composite material. In one exemplary embodiment, the mixing is performed using a suitable mixer, such as a Sigma-type mixer. In one embodiment, the polymer material may possess a desired viscous state at substantially room temperature and may not need to be heated. As discussed above, it is often preferable to mix the composite material until the ceramic filler material is substantially evenly distributed throughout the polymer material. Subsequently, the composite material is extruded or pressed through an orifice of a die. As the composite material exits the orifice, it is cut into small, semi-cylindrical pieces, or pellets. This compounding process is usually performed using a twin screw extruder. Alternatively, in some embodiments, the composite material can be directly inserted into a mold. In other contemplated embodiments, the composite material can be formed into at least one block that is subsequently altered into a desired shape.

In one embodiment, prior to, or contemporaneous with, the compounding process described above, the ceramic filler material, or the composite material, may be treated with a coupling agent including, without limitation, at least one of a silane, a metal alkoxide, and alkoxy zirconate. Coupling agents, in general, can form chemical bonds including, without limitation, hydrogen bonds, covalent bonds, and ionic bonds, between an organic material and an inorganic material. Coupling agents can also physically couple an organic and an inorganic material. In one embodiment, a silane is applied to the ceramic filler material. Silanes, such as N-(2-aminoethyl)-3-aminopropyltrimethoxysilane and Tris(3-trimethoxysilylpropyl) isocyanurate include a silicon atom, a hydrolyzable group, and a nonhydrolyzable organofunctional group. The organofunctional group can form a covalent bond with an organic material such as the polymer material component of the composite material. The hydrolyzable group can form a covalent bond with an inorganic material, e.g., the ceramic filler material of the composite material. In another embodiment, a zirconate coupling agent such as Ken-React® Kz TPP (for PEEK or PAEK) or Ken-React® NZ 12 (for PMMA) from Kenrich Petrochemicals, Inc. (Bayonne, N.J. 07002) is added during the compounding process. These zirconate coupling agents are designed especially for high-temperature composite processing. The concentration of zirconate coupling agents can be as low as about 0.1%, or 0.2% by weight, or as high as about 0.5%, 1.0% or 10% by weight of the total composition. In another embodiment, a titanium alkoxide, such as a titanium methoxide, Ti(OCH₃)₄, can be used to treat the ceramic filler materials for the composites, and can be added during the compounding process.

In one embodiment, a silane is added to the composite material during the compounding process described above. Generally, the silane, in an alcohol carrier, is dispersed by spraying the solution onto a pre-blend of ceramic filler material and polymer material. The silane coupling agent can be mixed in the alcohol carrier at a concentration as low as about 0.2%, or 0.5% by weight or as high as up to about 1.0%, 5.0%, or 10% by weight. Vacuum devolatization of byproducts of the silane reaction with the ceramic filler material and the polymer material may be necessary.

In another embodiment, the silane material is applied to the ceramic filler material prior to the compounding process. The silane material may be sprayed directly onto the ceramic filler material in an alcohol solution. The ceramic filler material is then dried in a mixer. In another embodiment, the ceramic filler material is placed into a silane ethanol solution and then stirred. Subsequently, the silane solution is decanted leaving behind a sediment of coated ceramic filler material. The ceramic filler material is then rinsed with ethanol and permitted to dry and cure at room temperature.

Regardless of the manner in which the coupling agent is applied, once the composite material has been pelletized, the pellets are then transferred into an injection molding machine, in which the composite material, particularly the polymer material component, is heated to obtain a desired viscosity and is then injected into a mold. In one embodiment, the composite material may possess a desired viscous state at substantially room temperature and may not need to be heated. During this process, the ceramic filler material remains substantially suspended within the polymer material. After sufficient time has elapsed, the dental device is in a substantially solid form and can be removed from the mold. Subsequent to the injection molding process, the dental device can be machined and polished to reduce undesired deformities and surface roughness. Additionally, the surface of the dental device may be treated by a gas plasma cleaning process to enhance bonding between the dental device and an adhesive, if necessary.

In some embodiments, the composite material can be molded over, in or around another component such as a titanium dental device. In these embodiments, the component is placed in the mold cavity prior to the injection process. During the injection process, the composite material is injected around at least a portion of the component. The composite material may form a chemical bond with the component or may mechanically interlock with the component to create an integrated device. These embodiments may be advantageous in applications that require certain material properties in one portion of the integrated dental device and other material properties in another portion of the device.

An exemplary insert molded abutment is illustrated in FIGS. 8 and 9. In this embodiment, composite material, as described herein, is insert molded over titanium abutment screw 52 to form abutment body 50. Abutment screw 52 includes flanges 54 and 56 extending radially from an axially-extending shank portion 58. During the injection molding process, the composite material flows between flanges 54 and 56 to mechanically interlock body 50 to abutment screw 52 after the composite material solidifies and thereby prevent relative movement therebetween. In other embodiments, relative rotational movement may be possible between body 50 and abutment screw 52. In the embodiment illustrated in FIGS. 8 and 9, abutment body 50 is molded to the anatomical shape of a tooth. However, in other embodiments, body 50 may be molded having other configurations including, without limitation, a substantially cylindrical body. Insert molding processes may also be used to place a metallic or fiber reinforcement insert, or element, in a prosthetic component. The insert may be placed in the prosthetic component where thin cross sections in the prosthetic component are dictated by a patient's anatomy. The insert may also be placed where occlusal loads may induce particularly high stresses in the prosthetic component. In some embodiments, the injection molding processes can be used to orient the fibers of the filler material within the polymer material in directions that best resist stresses, including stresses predicted by testing and finite element analysis. In at least one embodiment, the insert is substantially encapsulated by the composite material.

The polymer material may be selected such that its color closely approximates a desired color. Furthermore, the ceramic filler material may be used to adjust the color of the dental device. For example, titanium dioxide may be used as a ceramic filler material to give the composite material a white or substantially white color. In one embodiment, a colorant, or pigment, may also be added to the composite material to adjust the color of the dental device. In one embodiment, the colorant may include at least one of a metal oxide and an inorganic material. In another embodiment, a dental device may be constructed from a series of injection molding processes. In this embodiment, several different composite materials are injected sequentially to form an integrated dental device. The colors of these composite materials may be selected to provide a range or gradient of colors in the same device. Further, the different composite materials may be selected to provide different structural or chemical properties in different regions of the dental device. For example, co-molding processes can be used to mold a component using two different plastics. In one embodiment, a mechanically strong carbon reinforced material could be used to form an inner portion of a prosthetic component while a TiO₂ filled material could be used to form an outer layer. The carbon reinforced material may be a dark color, which is unattractive for a dental application, but may be covered with the white, esthetically pleasing TiO₂ filled material. In other embodiments, other optical properties including, without limitation, reflectance, opacity and specularity can be adjusted by the selection of the polymer material, the ceramic filler material, and additives. The surface finish of the dental device can also be adjusted by the selection of the polymer material, the ceramic filler material and additives.

### EXAMPLES

Below are examples illustrating exemplary composite formulations. Although several embodiments of dental abutments are described below, the materials disclosed herein can also be used to produce other dental prostheses. All percentages below are weight percentages, unless otherwise indicated.

### Examples 1-9

### Example 1

In this example, the polymer material is polyether ether ketone (PEEK) and the ceramic material is alumina fibers, i.e., Al₂O₃. The alumina fibers have a diameter of about 120 μm and a length of about 1-2 mm. To treat the alumina fibers with a silane, ethanol and water were mixed to form a solution having 95 wt. % ethanol and 5 wt. % water. Thereafter, a silane, such as, N-(2-aminoethyl)-3-aminopropyltrimethoxysilane, e.g., was mixed into the solution at a concentration of about 5 wt. % of the ethanol solution. The Al₂O₃ fibers were then mixed into the solution at an approximate 1:100 weight ratio of silane to ceramic. Thereafter, the solution was agitated for about 20-30 minutes and the ceramic fillers were decanted and then dried at about 110° C. for about 10-30 minutes. The PEEK was milled into a powder and sieved with a 200 mesh sieve. The treated alumina fibers were then added to the PEEK polymer powder such that the mixture contained about 30 wt. % alumina fibers. More specifically, the alumina fibers comprised about 30% of the combined weight of the alumina fibers and PEEK powder mixed together. The PEEK powder and alumina fibers were mixed for about 10 minutes using a Sigma-type mixer and were compounded with a ZSK-25 twin-screw extruder. Thereafter, the composite was heated and injected into a mold cavity to form a dental abutment. Once cooled, the abutment was removed from the mold and machined and/or cleaned as required.

### Example 2

In this example, the method of producing an abutment was the same method as described in Example 1, except the PEEK polymer material was replaced with Ultem 1010. During the milling process, Ultem 1010 was milled down to average grain size of about 2 mm.

### Example 3

In this example, the method of producing an abutment was the same method as described in Example 1, except the PEEK polymer material was replaced with polyether ketone ketone (PEKK).

### Example 4

In this example, the polymer material is polyether ketone ketone (PEKK) and the ceramic material is zirconia fibers (ZrO₂). The zirconia fibers have a diameter of about 120 μm and a length of about 1-2 mm. Unlike Example 1, the zirconia fibers, in this example, were not treated with a silane. Similar to Example 1, the PEKK was milled into a powder and sieved with a 200 mesh sieve. The zirconia fibers were then added to the PEKK polymer powder such that the mixture contained about 30 wt. % zirconia fibers. The PEKK and zirconia fibers were mixed for about 10 minutes using a Sigma-type mixer and were compounded with a ZSK-25 twin-screw extruder. Thereafter, the mixture was heated and injected into a mold cavity to form a dental abutment.

### Example 5

In this example, the method of producing an abutment was the same as the method described in Example 1, except the PEEK polymer material was replaced with polyether ketone ketone (PEKK) and the alumina fibers were replaced with calcium phosphate nanoparticles which were not treated with a silane. The calcium phosphate particles, in this example, included about 70% hydroxyapatite particles and about 30% tricalcium phosphate particles. Further, during the mixing process with the Sigma-type mixer, the calcium phosphate particles were mixed with the PEKK powder for about 20 minutes, instead of the 10 minutes of mixing as described in Example 1.

### Example 6

In this example, the polymer material is polyether ketone ketone (PEKK) and the ceramic material is zirconia nanoparticles (ZrO₂). The zirconia particles had an average size of about 70 nm. Unlike Example 1, the zirconia particles, in this example, were not treated with a silane. Similar to Example 1, the PEKK was milled into a powder and sieved with a 200 mesh sieve. The zirconia particles were then added to the PEKK polymer powder such that the mixture contained about 30 wt. % zirconia particles. The PEKK and zirconia fibers were mixed for about 20 minutes using a Sigma-type mixer and were compounded with a ZSK-25 twin-screw extruder. Thereafter, the mixture was heated and injected into a mold cavity to form a dental abutment.

### Example 7

In this example, the method of producing an abutment was the same method as described in Example 1, except the PEEK polymer material was replaced with polyether ketone ketone (PEKK) and the alumina fibers were replaced with zirconia fibers and titanium dioxide (TiO₂) microparticles. The zirconia fibers were silanized as described in Example 1 except the silane was mixed into an ethanol solution comprising about 95 wt. % ethanol and about 5 wt. % water. The titanium dioxide particles were not silanized in this example, however, in other embodiments, they can be. During the mixing process, the zirconia fibers were added to the PEKK powder at about 30 wt. % and the titanium dioxide particles were added at about 7 wt. %.

### Example 8

In this example, the method of producing an abutment was the same method as described in Example 1, except the alumina fibers were replaced with zirconia (ZrO₂) fibers. The zirconia fibers had a diameter of about 120 μm and a length of about 1-2 mm. The zirconia fibers were silanized as described in Example 1 except the silane was mixed into a solution comprising about 95 wt. % ethanol and about 5 wt. % water.

### Example 9

In this example, the method of producing an abutment was the same as Example 1, except the PEEK polymer material was replaced with polyether ketone ketone (PEKK) and the alumina fibers were replaced with titanium dioxide (TiO₂) microparticles. In this example, the titanium dioxide particles were not treated with a silane. Further, during the mixing process with the Sigma-type mixer, the titanium dioxide particles were mixed with the PEKK powder at a ratio of about 10 wt. % titanium dioxide particles to about 90% PEKK powder which were mixed for about 20 minutes instead of the 10 minutes as outlined in Example 1.

TABLE I

| | | | | Average | | Average | | Avg. | Max | | Izod |
|---|---|---|---|---|---|---|---|---|---|---|---|
| | | | | Modulus of | | Yield | Yield | Max | Strain | | Impact |
| | | | | Elasticity | Modulus | Strength | Strength | Strain | Std. | Shore D | Energy |
| Example | Polymer | Ceramic | Silane | (ksi) | Std. Dev. | (ksi) | Std. Dev. | (%) | Dev. | Hardness | (J/m) |
| 1 | PEEK | 30 wt. % | yes | 746 | 58 | 12.5 | 0.1 | 8.3 | 1.6 | * | * |
| | | Al₂O₃ fibers | | | | | | | | | |
| 2 | Ultem | 30 wt. % | yes | 712 | 82 | 13.0 | 0.1 | 4.1 | 0.3 | * | * |
| | 1010 | Al₂O₃ fibers | | | | | | | | | |
| 3 | PEKK | 30 wt. % | yes | 791 | 100 | 11.2 | 0.1 | 6.8 | 1.2 | * | * |
| | | Al₂O₃ fibers | | | | | | | | | |
| 4 | PEKK | 30 wt. % | no | 712 | 82 | 11.8 | 0.1 | * | * | * | * |
| | | ZrO₂ fibers | | | | | | | | | |
| 5 | PEKK | 30 wt. % | no | 962 | 164 | 11.0 | 0.2 | 3.4 | 0.4 | * | * |
| | | calcium | | | | | | | | | |
| | | phosphates | | | | | | | | | |
| | | particles | | | | | | | | | |
| 6 | PEKK | 30 wt. % | no | 742 | 112 | 13.5 | 0.1 | 37.4 | 3.0 | * | * |
| | | ZrO₂ | | | | | | | | | |
| | | nanoparticles | | | | | | | | | |
| 7 | PEKK | 30 wt. % | yes | 590 | 42 | 9.7 | 0.1 | 9.0 | 2.1 | 86 | 79 |
| | | ZrO₂ fibers | | | | | | | | | |
| | | and 7 wt. % | | | | | | | | | |
| | | TiO₂ | | | | | | | | | |
| | | particles | | | | | | | | | |
| 8 | PEEK | 30 wt. % | yes | 796 | 122 | 12.8 | 0.1 | 7.9 | 1.6 | 90 | 47 |
| | | ZrO₂ fibers | | | | | | | | | |
| 9 | PEKK | 10 wt. % | no | 512 | 75 | 10.8 | 0.1 | 45.9 | 12.2 | * | * |
| | | TiO₂ | | | | | | | | | |
| | | particles | | | | | | | | | |

Referring to Table I, the composite material produced by the method disclosed in Example 1 had a modulus of elasticity, or tensile modulus, of about 746 ksi, including values within ±1 standard deviation from the average value. Thus, in this example, the range of an average modulus of elasticity of about 746 ksi would include values as low as 688 ksi and as high as 804 ksi. To determine the modulus of elasticity, or tensile modulus, for the composite material, as is known in the art, a specimen comprised of the composite material was placed in tension and the resulting deflection was recorded. The modulus of elasticity can also be determined by placing a specimen of the composite material in compression and similarly recording the deflection. The composite material produced by the method disclosed in Example 2 had a tensile modulus, or an average modulus of elasticity, of about 712 ksi including a modulus as low as 630 ksi and as high as 784 ksi. Similarly, referring to Example 1, having an average yield strength of about 12.5 ksi includes values within ±1 standard deviation from the average value. Thus, in this example, this range would include values as low as 12.4 ksi and as high as 12.6 ksi. Further, having an average maximum strain of about 8.3% includes values within ±1 standard deviation from the average value. Thus, in this example, this range would include values as low as 6.7% and as high as 9.9%. In another embodiment, the composite material has an average maximum strain greater than or equal to 0.5 percent.

### Prophetic Examples 10-12

### Example 10

In this prophetic example, the method of producing an abutment is the same as the method described in Example 1, except the alumina fibers are replaced with alumina nanoparticles having an average size of about 70 nm. The alumina fibers are silanized as described in Example 1 except the silane is mixed into a solution comprising about 95 wt. % ethanol and about 5 wt. % water. Once silanized, the alumina particles are mixed with the PEEK polymer powder at about 14 wt. % alumina particles.

### Example 11

In this prophetic example, the method of producing an abutment is the same as the method described in Example 10, except that the alumina nanoparticles are treated with a zirconate coupling agent, such as Ken-React from Kenrich Petrochemicals, Inc., instead of a silane. The zirconate coupling agent is mixed with the PEEK powder and alumina fibers at about 0.3 wt. % relative to the combined weight of the PEEK polymer powder and alumina fibers and then mixed.

### Example 12

In this prophetic example, the method of producing an abutment is the same as the method described in Example 9, except that the titanium dioxide particles are treated with a coupling agent, such as a silane, for example.

As seen in Table 1, the modulus of elasticity of the composite material depends on the polymer material, the type and quantity of ceramic material mixed within the polymer material, and whether a coupling agent, such as a silane, is used. The modulus of elasticity also depends on whether the ceramic material includes continuous or non-continuous fibers, and whether the fibers are oriented with the load directions. For a continuous fiber-reinforced composite, i.e., composites where the fiber length is much larger than the critical fiber length, in which the fiber is aligned in the same direction of the load, the modulus of elasticity of the composite, E_{c}, is determined by Equation (1) below:
E_{c}=VₘEₘ+V_{f}E_{f} Equation (1)
wherein Eₘ and E_{f} are the moduli of the polymer matrix and the ceramic fibers, respectively, and Vₘ and V_{f} are the volumes of polymer matrix and ceramic fibers, respectively, such that Vₘ+V_{f}=1. The critical length of the fiber is dependent on the fiber diameter, the fiber's ultimate strength, and the bond strength between the fiber and the plastic matrix. For a number of combinations, this critical length is on the order of about 1 mm. For a continuous fiber-reinforced composite in which the fiber is aligned in the transverse direction to the load, the composite modulus of elasticity is determined by Equation (2) below:
1/E_{c}=Vₘ/Eₘ+V_{f}/E_{f}. Equation (2)
For discontinuous and randomly oriented fibers, the composite modulus of elasticity is determined by Equation (3) below:
E_{c}=VₘEₘ+KV_{f}E_{f} Equation (3)
in which K is a fiber efficiency parameter which depends upon the ratio of V_{f} and E_{f}/Eₘ. K is usually in the range of 0.1-0.6. In any event, the upper and lower bounds of the modulus of elasticity for the composites composed of particulate fillers are determined by Equations (4) and (5) below:
E_{c}(upper)=VₘEₘ+VₚEₚ Equation (4)
E_{c}(lower)=EₘEₚ/(VₘEₚ+VₚEₘ) Equation (5):
Referring to Table I, although the modulus of elasticity of the composite materials developed in Examples 1-9 is within a range from about 512 ksi to about 962 ksi, the modulus of elasticity can be improved to about 1000 ksi, 2000 ksi, or 3000 ksi and, in some further embodiments, the modulus of elasticity can be improved to about 6000 ksi. This improvement can be achieved by increasing the ceramic material content in the composites from 30% to 50% or even 70%, for example, increasing the fiber aspect ratio, i.e., the ratio of fiber length to diameter, from about 10 to about 100 or even higher, for example, further improving the interface, or bonding, between the ceramic and polymer materials via coupling agents, for example, and improving the compounding and molding processes to better mix the ceramic material within the plastic material to get a more even distribution and to decrease the inclusion of impurities and porosities in the composite material.

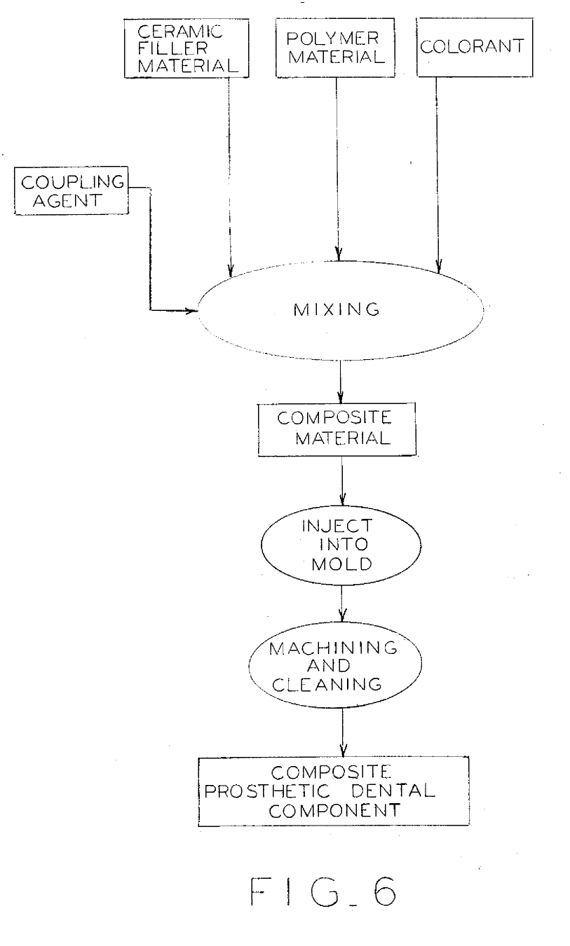

In another form of the invention, prosthetic dental devices, including implants, abutments, and healing screws are constructed from another composite material. In one embodiment, the composite material includes a ceramic matrix having pores, such as pores 38 illustrated in FIG. 4, and an organic material, such as a thermoset plastic, contained in the pores, such as material 40 illustrated in FIG. 5. The ceramic matrix can be a ceramic material including yttria-stabilized zirconia, magnesium-stabilized zirconia, alumina, calcium phosphates, or a combination of ceramic materials.

The organic material can be a thermoset plastic material including, without limitation, bisphanol glycidyl methacrylate (Bis-GMA), methylmethacrylate (MMA), triethylene glycol dimethacrylate (TEGDMA), or a combination of thermoset plastics. Additionally, the organic material can be comprised of, without limitation, a large class of monomers, oligomers and polymers, such as acrylics, styrenics and other vinyls, epoxies, urethanes, polyesters, polycarbonates, polyamides, radiopaque polymers and biomaterials.

Further, the organic material can be comprised of, without limitation, one or more of the following compounds: acenaphthylene, 3-aminopropyltrimethoxysilane, diglycidyletherbisphenol, 3-glycidylpropyltrimethoxysilane, tetrabromobisphenol-A-dimethacrylate, polyactide, polyglycolide, 1,6-hexamethylene dimethacrylate, 1,10-decamethylene dimethacrylate, benzyl methacrylate, butanediol monoacrylate, 1,3-butanediol diacrylate (1,3-butylene glycol diacrylate), 1,3-butylene glycol dimethacrylate), 1,4-butanediol diacrylate, 1,4-butanediol dimethacrylate, n-butyl acrylate, n-butyl methacrylate, t-butyl acrylate, t-butyl methacrylate, n-butyl vinyl ether, t-butylaminoethyl methacrylate, 1,3-butylene glycol diacrylate, cyclohexyl acrylate, cyclohexyl methacrylate, n-decyl acrylate, n-decyl methacrylate, diethylene glycol diacrylate, diethylene glycol dimethacrylate, dipentaerythritol monohydroxypentaacrylate, 2-ethyoxyethoxyethyl acrylate, 2-ethoxyethyl methacrylate, ethoxylated bisphenol A diacrylate, ethoxylated bisphenol A dimethacrylate, ethoxylated trimethylolpropane triacrylate, ethyl methacrylate, ethylene glycol dimethacrylate, 2-ethylhexyl acrylate, 2-ethylhexyl methacrylate, furfuryl methacrylate, glyceryl propoxy triacrylate, 1,6 hexanediol diacrylate, 1,6 hexanediol dimethacrylate, n-hexyl acrylate, n-hexyl methacrylate, 4-hydroxybutyl acrylate, (butanediol monoacrylate), 2-hydroxyethyl acrylate, hydroxyethyl methacrylate, hydroxypropyl acrylate, hydroxypropyl methacrylate, isobornyl acrylate, isobornyl methacrylate, isobutyl acrylate, isobutyl methacrylate, isobutyl vinyl ether, isodecyl acrylate, isodecyl methacrylate, isooctyl acrylate, isopropyl methacrylate, lauryl acrylate, lauryl methacrylate, maleic anhydride, methacrylic anhydride, 2-methoxyethyl acrylate, methyl methacrylate, neopentyl acrylate, neopentyl methacrylate, neopentyl glycol diacrylate, neopentyl glycol dimethacrylate, n-octadecyl acrylate, (stearyl acrylate), n-octadecyl methacrylate, (stearyl methacrylate), n-octyl acrylate, pentaerythritol tetraacrylate, pentaerythritol triacrylate, 2-phenoxyethyl acrylate, 2-phenoxyethyl methacrylate, 2-phenylethyl methacrylate, phenyl methacrylate, polybutadiene diacrylate oligomer, polyethylene glycol 200 diacrylate, polyethylene glycol 400 diacrylate, polyethylene glycol 200 dimethacrylate, polyethylene glycol 400 dimethacrylate, polyethylene glycol 600 dimethacrylate, polypropylene glycol monomethacrylate, propoxylated neopentyl glycol diacrylate, stearyl acrylate, stearyl methacrylate, 2-sulfoethyl methacrylate, tetraethylene glycol diacrylate, tetraethylene glycol dimethacrylate, tetrahydrofurfuryl acrylate, tetrahydrofurfuryl methacrylate, n-tridecyl methacrylate, triethylene glycol diacrylate, triethylene glycol dimethacrylate, trimethylolpropane triacrylate, trimethylolpropane trimethacrylate, 3-methacryloxypropyltrimethoxysilane, trimethylsilylmethacrylate, (trimethylsilymethyl)methacrylate, tripropylene glycol diacrylate, tris(2-hydroxyethyl)isoyanurate triacrylate, vinyl acetate, vinyl caprolactam, n-vinyl-2-pyrrolidone, zinc diacrylate and zinc dimethacrylate.

Referring to FIG. 7, a dental implant or an abutment of the present embodiment of the invention can be constructed from a series of processes including an injection molding process and a heating process. In one embodiment, a fluid containing ceramic particles and a binder material such as water, for example, is injected into a mold. The fluid may resemble a slurry or it may resemble a viscous paste. The composite material is then heated to evaporate a substantial quantity of the binder material to create a substantially rigid ceramic structure of the prosthetic dental device. The evaporated binder material leaves behind pores which are then infiltrated with an organic material. In this embodiment, the ceramic structure and the organic material contained therein are reheated to promote bonding between the ceramic matrix and the organic material. In one embodiment, a coupling agent can be applied to the ceramic matrix to further promote bonding between the organic material and the ceramic matrix. These processes are discussed in further detail below.

In one embodiment of the invention, a viscous composite material is comprised of ceramic particles and water. The water binds the ceramic particles together primarily through hydrogen bonding. In some embodiments, additional binder materials such as polyvinyl alcohol and polyethylene glycol, for example, are mixed into the composite material and further adhere the ceramic particles together. In these embodiments, the binder may chemically bond with the ceramic particles including, without limitation, hydrogen bonds, covalent bonds, and ionic bonds. In another embodiment, at least one binder material is used in lieu of water. In some embodiments, the binder material and the ceramic particles are mixed until a consistent, homogeneous composite material is obtained to avoid inconsistent material properties in the final dental device. It may also be advantageous to mix deflocculates into the composite material. Deflocculates, such as citric acids, sodium citrate, sodium tartrate and ammonium citrate, for example, reduce clumping of the ceramic particles and act to substantially evenly distribute the ceramic particles throughout the composite material.

In one embodiment, after the composite material has been produced, it is transferred into an injection molding machine. Commonly, injection molding machines also include a drying mechanism for removing unwanted or excessive moisture from the composite material. In this embodiment, dryers may also be used to increase the viscosity of the composite material by evaporating a quantity of the water. Further, the composite material may also be heated in the injection barrel of the injection molding machine further evaporating water and increasing the viscosity of the composite material. In some embodiments, the composite material has a consistency approximating paste before it is injected into the cavity. In other embodiments, the fluid can have a lower viscosity. After sufficient time has elapsed, the fluid cools into a substantially solid ceramic structure or matrix. Once removed from the mold, the structure is subjected to a subsequent heating process.

In this embodiment, the ceramic structure is then heated at about 1000 degrees Celsius subsequent to the molding process discussed above. During this process, a substantial quantity of the remaining water in the ceramic structure is evaporated leaving pores in the ceramic structure. Similarly, the additional binder materials and deflocculates added into the composite material can also evaporate during the heating process leaving behind additional pores in the matrix. The quantity of pores in the ceramic matrix will depend, in part, on the duration and temperature of the heating process. In some embodiments, the quantity of pores will also depend on the process used to produce the ceramic matrix. In particular, due to the high packing pressure of the injection molding process discussed above, the ceramic matrix may be tightly packed together and, in some circumstances, insufficient porosity may result. To ameliorate this problem, a porogen material may be mixed in the composite material. Porogen materials, such as wax particles, e.g., occupy space in the ceramic matrix. In some embodiments, the wax particles can include at least one of naphthalene and paraffin. The porogen materials remain in the matrix until the heating process during which they are volatilized and evaporated leaving behind additional pores in the matrix. Other processes, such as slip casting, for example, create a ceramic matrix slightly less packed than the injection molded matrices and thus may not require additional porogen materials. Other methods of increasing porosity include, e.g., inducing gas producing chemical reactions in the composite material to create pores therein.

In one embodiment, the amount and/or size of the pores left behind in the ceramic structure can be controlled by the type and/or quantity of porogen material used. For example, if a relatively larger quantity of porogen material is used, more pores will be left behind in the ceramic structure during the heating process described above to provide a greater overall pore volume, and vice-versa. Ceramic structures having additional and/or larger pores can receive larger amounts of an organic or plastic material within the pores. The organic or plastic materials, when infiltrated into the pores, can improve the toughness and other material properties, such as the modulus of elasticity, of the ceramic material. Accordingly, the material properties of the dental device can be controlled by controlling the amount of porogen mixed within the ceramic particles and volatized during the above-discussed heating process. In one embodiment, as discussed in greater detail below, a rapid prototyping technique may be used to create pores and control the porosity of a ceramic body.

In one embodiment, after the desired ratio of composite constituents has been determined, a quantity of ceramic particles is provided wherein the ceramic particles comprise one of the composite constituents. A quantity of porogen particles is also provided and mixed with the ceramic particles to form a mixture of ceramic and porogen particles. Thereafter, the mixture is heated at a temperature sufficient to evaporate at least some of the porogen particles, whereby the heating step creates a quantity of pores in the mixture of sufficient size and number to achieve the desired ratio of composite constituents when at least one additional composite constituent is introduced into the pores. Thereafter, an organic material is introduced into the pores, the organic material comprising an additional composite constituent.

As discussed above, to improve the toughness of the ceramic matrix, an organic material is infiltrated, or introduced, into the above-mentioned pores. In one embodiment, the organic material is a thermoset plastic resin. In this embodiment, before the resin is introduced into the pores, the ceramic matrix is preheated to a temperature as low as about 50 or 70 degrees Celsius or as high as about 140 or 200 degrees Celsius, but typically about 100 degrees Celsius. Subsequently, the heated ceramic matrix is immersed into a bath containing the thermoset plastic resin. In some embodiments, providing a temperature gradient between the ceramic matrix and the resin bath facilitates the infiltration of the resin. If the thermoset plastic resin is MMA, the immersion is commonly carried out at room temperature. However, if the resin is Bis-GMA, or a mixture of Bis-GMA and TEGDMA, the bath may need to be heated, to lower the viscosity of the resin, to a temperature as low as about 50 or 60 degrees Celsius or as high as about 80 or 100 degrees Celsius, but typically about 70 degrees Celsius. In this embodiment, the ceramic matrix remains immersed in the bath between approximately 8 and 24 hours.

Unlike the thermoplastic or polymer material discussed above, thermoset resins are unlinked monomers. In one embodiment, initiators, such as benzoyl peroxide and dicumyl peroxide may be included in the above-mentioned bath to promote the polymerization of the thermoplastic monomer resins. Initiators are organic molecules that start polymerization by which monomers are converted into the repeating units of a polymer. In one embodiment, the initiators may be added in amounts up to about 2% or 5% weight of the resin monomers, but typically are added in amounts only up to about 1% weight of the resin monomers. To promote bonding between the thermoset resins and the ceramic matrix, a coupling agent may be applied to the ceramic matrix prior to the immersion process discussed above. In one embodiment, the coupling agent may be applied by soaking the ceramic structure in an alcohol solution of a silane and then drying it at a temperature higher than room temperature, typically as low as about 100 degrees Celsius in one embodiment and as high as about 110 degrees Celsius in another embodiment, to promote the bonding of the silane to the ceramic matrix. In one embodiment, the ceramic structure is heated to a temperature as low as about 25 or 50 degrees Celsius or as high as about 150 or 200 degrees Celsius. As discussed above, a silane can covalently bond with inorganic materials, such as the ceramic matrix, and organic materials. Thus, during the above-discussed immersion process, the organic thermoset resins bond with the silane, which is bonded to the ceramic structure, thereby improving the bond between the ceramic structure and the resin.

After the immersion process, in this embodiment, the thermoset resin is thermally cured in an oven at a temperature as low as about 50, 60 or 80 degrees Celsius or as high as about 120 or 150 degrees Celsius, but typically about 100 degrees Celsius, between about 4 and 24 hours, depending on the concentration of initiators, choice of monomers and the oven temperatures. During this curing process, the bonds between the thermoset resin monomers and the coupling agent are improved. After the curing process, the dental devices are machined and polished to remove undesired irregularities and rough surfaces. The surface of the dental device may be treated by a gas plasma cleaning process to enhance bonding between the dental device and an adhesive.

The processes of the present embodiment of the invention may be used as an over-molding process where the composite material flows over, in, or around another component in the mold cavity. Additionally, the organic and ceramic materials may be selected such that their colors closely resemble a desired dentition color. A colorant may be added to the composite material to adjust the color of the dental device. In other embodiments, other optical properties including, without limitation, reflectance, opacity and specularity can be adjusted by the selection of the polymer material, the ceramic filler material and additives. The surface finish of the dental device can also be adjusted by the selection of the polymer material, the ceramic filler material and additives.

In another form of the invention, a prosthetic dental device is constructed using a fused deposition, i.e., rapid prototyping, process. During this process, in one embodiment, a polymer material and a ceramic filler material are mixed together. Subsequently, the mixture is then deposited in layers to form a dental prosthetic device comprised of a composite material including the polymer material and the ceramic filler material. In one embodiment, the mixture is applied in layers by an apparatus including a computer, a valve operated by instructions from the computer, and a nozzle positioned by instructions from the computer. In this embodiment, the nozzle is driven along a pre-determined path. Concurrently, the mixture can flow from the nozzle onto a work surface when the valve is opened pursuant to the instructions of the computer. Subsequently, the nozzle, as directed by the computer, applies additional layers along this path, or other predetermined paths. These layers fuse together to comprise a prosthetic dental device. It is contemplated that a clinician could create custom dental abutments in the clinician's office using the process described above thereby reducing the time to obtain a custom abutment.

While this invention has been described as having exemplary designs, the present invention may be further modified within the spirit and scope of the disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A prosthetic dental device, comprising:
a body formed of a composite material, said composite material including a polymer material and a ceramic material mixed within said polymer material, said composite material having a tensile modulus greater than or equal to 630 ksi.

2. The prosthetic dental device of claim 1, wherein said tensile modulus of said composite material is between 630 ksi and about 962 ksi.

3. The prosthetic dental device of claim 1, wherein said ceramic material includes calcium phosphate particles.

4. The prosthetic dental device of claim 1, wherein said composite material further includes a coupling agent bonding said polymer material to said ceramic material, said composite material having an average maximum strain greater than or equal to 0.5 percent.

5. The prosthetic dental device of claim 1, wherein said ceramic material includes a plurality of fibers, each fiber defining a longitudinal axis and variable cross-sections transverse to said axis defining relatively wide first portions connected by relatively narrow second portions and pockets defined intermediate adjacent first and second portions, said polymer material received within said pockets.

6. The prosthetic dental device of claim 1, wherein said ceramic material includes zirconia fibers, said composite material further including titanium dioxide mixed therein in addition to said ceramic material.

7. The prosthetic dental device of claim 1, wherein said composite material further comprises at least one pigment mixed therein in addition to said ceramic material.

8. The prosthetic dental device of claim 1, wherein said prosthetic dental device is an abutment.

9. A prosthetic dental device, comprising:
a body comprised of a composite material, said composite material including a polymer material and a ceramic material mixed within said polymer material, said ceramic material including a plurality of fibers, each fiber defining a longitudinal axis and variable cross-sections transverse to said axis defining relatively wide first portions connected by relatively narrow second portions and pockets defined intermediate adjacent first and second portions, said polymer material received within said pockets.

10. The prosthetic dental device of claim 9, further comprising ceramic particles bonded to said fibers.

11. The prosthetic dental device of claim 9, wherein said ceramic particles include titanium dioxide particles.

12. The prosthetic dental device of claim 9, wherein said composite material further comprises at least one pigment mixed therein in addition to said ceramic material.

13. The prosthetic dental device of claim 9, wherein said composite material further includes a coupling agent, said coupling agent bonding said ceramic material to said polymer material.

14. The prosthetic dental device of claim 9, wherein said prosthetic dental device is an abutment.

15. The prosthetic dental device of claim 9, wherein said body is comprised of a second composite material.

16. A prosthetic dental device, comprising:
an implant coupling structure configured to connect the dental device to an implant; and
a body comprised of a composite material including a polymer material and ceramic nanoparticles dispersed within said polymer material.

17. The prosthetic dental device of claim 16, said composite material further including titanium dioxide particles mixed therein.

18. The prosthetic dental device of claim 16, wherein said composite material further comprises at least one pigment mixed therein in addition to said ceramic material.

19. The prosthetic dental device of claim 16, wherein said dental device is an abutment.

20. The prosthetic dental device of claim 16, wherein said composite material further includes a coupling agent, said coupling agent bonding said ceramic material to said polymer material.

21. The prosthetic dental device of claim 16, wherein said implant coupling structure is comprised of titanium.

22. The prosthetic dental device of claim 16, wherein said body is comprised of a second composite material.

23. A prosthetic dental device, comprising:
a reinforcing element; and
a composite material molded about said reinforcing element to form the dental device, said composite material comprised of a polymer material and a ceramic material dispersed within said polymer material.

24. The prosthetic dental device of claim 23, wherein said reinforcing element is metal.

25. The prosthetic dental device of claim 23, wherein said reinforcing element is encapsulated by said composite material.

26. The prosthetic dental device of claim 23, wherein said ceramic material includes oriented fibers.
